(19) United States
(12) Patent Application Publication
(10) Pub. No.: US 2025/0119000 A1
(43) Pub. Date: Apr. 10, 2025

(54) LAMINATED MAGNETIC MATERIAL AND METHOD FOR MANUFACTURING LAMINATED MAGNETIC MATERIAL

(71) Applicant: Proterial, Ltd., Tokyo (JP)

(72) Inventors: Yuki ISHIKAWA, Tokyo (JP); Shin NOGUCHI, Tokyo (JP); Kyohei AIMUTA, Tokyo (JP)

(73) Assignee: Proterial, Ltd., Tokyo (JP)

(21) Appl. No.: 18/729,164

(22) PCT Filed: Jan. 18, 2023
(86) PCT No.: PCT/JP2023/001418

§ 371 Date: Jul. 15, 2024

(30) Foreign Application Priority Data
Jan. 21, 2022 (JP) 2022-008043
Mar. 9, 2022 (JP) 2022-036711

(51) Int. Cl. H02K 1/02; H02K 15/0273

(52) U.S. Cl. CPC H02K 1/02; H02K 15/0273; H02K 2213/03

(57) ABSTRACT

The present invention provides: a laminated magnetic material for a motor, the material having low core loss characteristics even in a high-frequency band; and a method for manufacturing said laminated magnetic material for a motor. Provided is a laminated magnetic material provided with a plurality of quenched alloy strips and a resin layer made of resin and disposed between the quenched alloy strips. The laminated magnetic material is characterized in that the adhesive stress σ [MPa] represented by the following equation is 1.8 MPa or greater when the modulus of elasticity of the resin at room temperature is denoted by γ [MPa], the coefficient of linear expansion of the resin at room temperature is denoted by α1 [1/K], the curing temperature of the resin is denoted by Ta [K], the coefficient of linear contraction of the resin during curing is denoted by β, the thickness of the resin is denoted by h1 [μm], the thickness of the quenched alloy strips is denoted by h2 [μm], the coefficient of linear expansion of the quenched alloy strips is denoted by α2 [1/K], and room temperature is denoted by RT. σ=h1/h2×γ×{(α1−α2)×(Ta−RT)+β}.

### TECHNICAL FIELD

The present invention relates to a laminated magnetic material that can be used, for example, as a motor core, and a method for manufacturing the laminated magnetic material.

### RELATED ART

As the world moves to reduce CO₂ emission, there is a demand for higher efficiency in motors, which account for 50% or more of the electricity consumption worldwide. Conventionally non-oriented electrical steel sheets have been used for the iron cores of motors, but it is expected to use amorphous alloys, which have characteristics of low loss that is about 1/10 of electrical steel sheets, instead. Since motors operate in a high-frequency band of several hundred Hz or more, it is important to suppress the loss due to eddy current generated in the iron cores, which is one of the iron loss characteristics. Generally, amorphous alloys are strips that have a higher volume resistivity than electrical steel sheets and have a thickness of about 25 μm, so amorphous alloys are advantageous in less eddy current loss. However, the extremely thin thickness is disadvantageous in terms of the manufacturing process, and since the thickness of the electrical steel sheet is about 0.35 mm, if an iron core having the same size as the electrical steel sheet is to be made out of an amorphous alloy, 10 times or more the number of laminations will be required, which imposes an excessive burden on the iron core manufacturing process. In order to solve this problem, as disclosed in Patent Document 1, for example, studies have been conducted on bonding and laminating multiple layers of amorphous alloy ribbons into a plate shape that can be handled in the same way as the electrical steel sheet.

In fact, a motor core using an adhesive laminate of amorphous alloys has been disclosed in Patent Document 2, and the technological development of amorphous alloy motors is expected to progress in the future.

### CITATION LIST

### Patent Documents

[Patent Document 1] Japanese Patent Application Laid-Open No. 2002-151316

[Patent Document 2] Japanese Patent Application Laid-Open No. 2005-160231

### SUMMARY OF INVENTION

### Technical Problem

However, in recent years, the influence of harmonics caused by high-speed motor rotation and inverter drive has led to a demand for reduction in iron loss in the high-frequency band and in particular the need to suppress an increase in eddy current loss, but the techniques described in Patent Document 1 and Patent Document 2 cannot meet these demands. Therefore, a new technique is required to prevent deterioration of the magnetic properties.

In view of the above, the present invention provides a laminated magnetic material having low iron loss characteristics even in a high-frequency band, and a method for manufacturing the laminated magnetic material.

### Solution to Problem

The present invention provides a laminated magnetic material, including a plurality of quenched alloy strips and a resin layer made of resin and disposed between the quenched alloy strips, in which an adhesive stress σ [MPa] represented by the following equation is 1.8 MPa or more where a modulus of elasticity of the resin at room temperature is denoted by γ [MPa], a coefficient of linear expansion of the resin at room temperature is denoted by α1 [1/K], a curing temperature of the resin is denoted by Ta [K], a coefficient of linear contraction of the resin during curing is denoted by β, a resin thickness of the resin is denoted by h1 [μm], a thickness of the quenched alloy strips is denoted by h2 [μm], a coefficient of linear expansion of the quenched alloy strips is denoted by α2 [1/K], and the room temperature is denoted by RT. [] represents the units.

$$σ = h 1 / h 2 \times γ \times \{ ( α1 - α2 ) \times ( T a - R T ) + β \}$$

In the present invention, it is preferable that the laminated magnetic material has an iron loss Pcm of 13.0 W/kg or less at a frequency of 2000 Hz and a maximum magnetic flux density of 1.0 T.

In the present invention, it is preferable that the laminated magnetic material has an eddy current loss Pe of 9.5 W/kg or less among an iron loss Pem at a frequency of 2000 Hz and a maximum magnetic flux density of 1.0 T.

The present invention provides a method for manufacturing a laminated magnetic material including a plurality of quenched alloy strips and a resin layer made of resin and disposed between the quenched alloy strips. The method includes a step of applying the resin, and a step of curing the resin by laminating the quenched alloy strips, in which an adhesive stress σ [MPa] represented by the following equation is 1.8 MPa or more where a modulus of elasticity of the resin at room temperature is denoted by γ [MPa], a coefficient of linear expansion of the resin at room temperature is denoted by α1 [1/K], a curing temperature of the resin is denoted by Ta [K], a coefficient of linear contraction of the resin during curing is denoted by β, a resin thickness of the resin is denoted by h1 [μm], a thickness of the quenched alloy strips is denoted by h2 [μm], a coefficient of linear expansion of the quenched alloy strips is denoted by α2 [1/K], and the room temperature is denoted by RT.

$$σ = h 1 / h 2 \times γ \times \{ ( α1 - α2 ) \times ( T a - R T ) + β \}$$

### Effects of Invention

According to the present invention, it is possible to provide a laminated magnetic material that has low iron loss characteristics even in a high-frequency band.

### BRIEF DESCRIPTION OF DRAWINGS

FIG. 1 is a schematic perspective view showing an embodiment of the laminated magnetic material for a motor of the present invention.

FIG. 2 is a schematic perspective view showing an embodiment of the laminated magnetic material for a motor of the present invention, in which the resin layer 2 is disposed between two quenched alloy strips 1.

FIG. 3 is a graph showing the f^{0.5} dependency of iron loss per cycle Pcm/f [W/kg/Hz] when the maximum magnetic flux density Bm=1.0 T in regard to Example 3, Example 4, and Comparative Example 5.

FIG. 4 is a photograph of the magnetic domain structure of Example 1.

FIG. 5 is a photograph of the magnetic domain structure of Example 2.

FIG. 6 is a photograph of the magnetic domain structure of Example 3.

FIG. 7 is a photograph of the magnetic domain structure of Example 4.

FIG. 8 is a photograph of the magnetic domain structure of Comparative Example 1.

FIG. 9 is a photograph of the magnetic domain structure of Comparative Example 7.

FIG. 10 is a photograph of the magnetic domain structure of Example 5.

FIG. 11 is a photograph of the magnetic domain structure of Example 6.

FIG. 12 is a photograph of the magnetic domain structure of Example 7.

FIG. 13 is a photograph of the magnetic domain structure of Comparative Example 4.

FIG. 14 is a photograph of the magnetic domain structure of Comparative Example 5.

FIG. 15 is a photograph of the magnetic domain structure of Comparative Example 6.

FIG. 16 is a photograph of the magnetic domain structure of Comparative Example 8.

### DESCRIPTION OF EMBODIMENTS

The inventors clarified the relationship between various physical properties of resin and bonding conditions and the adhesive stress σ determined by the various physical properties of the resin in forming a laminated magnetic material for a motor, and discovered a laminated magnetic material for a motor that maintains excellent magnetic properties even in a high-frequency band, thus completing the present invention. Details will be described hereinafter.

First, the inventors conducted a detailed study on the magnetic material to which resin (adhesive) was applied as disclosed in Patent Document 1. In other words, when attempting to manufacture a laminate by applying resin (adhesive) between quenched alloy strips such as amorphous alloy ribbons, the volume decreases when the resin (adhesive) is cured, and there is a difference in coefficient of thermal expansion between the amorphous alloy ribbons and the adhesive when heated and bonded. Therefore, the resin (adhesive) imparts adhesive stress to the amorphous alloy ribbons mainly in the in-plane direction.

Here, in the case of considering a plurality of quenched alloy strips and a resin layer made of resin (adhesive) and disposed between the quenched alloy strips, the adhesive stress σ [MPa] is represented by the following Equation 1 where the modulus of elasticity of the resin at room temperature is denoted by γ [MPa], the coefficient of linear expansion of the resin at room temperature is denoted by α1 [1/K], the curing temperature of the resin is denoted by Ta [K], the coefficient of linear contraction of the resin during curing is denoted by β, the thickness of the resin is denoted by h1 [μm], the thickness of the quenched alloy strips is denoted by h2 [μm], the coefficient of linear expansion of the quenched alloy strips is denoted by α2 [1/K], and the room temperature is denoted by RT. It should be noted that [] indicates units. Here, the room temperature RT is set to 296 [K].

$$σ = h 1 / h 2 \times γ \times \{ ( α1 - α2 ) \times ( T a - R T ) + β \} \qquad [ Equation 1 ]$$

Since the amorphous alloy ribbons have a large magnetostriction, the adhesive stress disrupts the magnetic domain structure of the amorphous alloy ribbons, causing the magnetic properties of the amorphous alloy ribbons to change. In particular, in the case where amorphous alloy ribbons are laminated to form laminated magnetic materials and a laminated core made of these laminated magnetic materials is used as a motor core, the desired characteristic is low iron loss in a high-frequency band, and to achieve this, it is necessary to reduce eddy current loss as much as possible. In order to reduce eddy current loss, it is effective to reduce the magnetic domain width of the amorphous alloy ribbons. The adhesive stress from the resin (adhesive) acts in various directions on the surface of the amorphous alloy ribbons, so if a certain level of stress or higher is applied, local magnetic anisotropy occurs due to the magnetoelastic effect, and the direction of the anisotropy varies from place to place. As a result, the magnetization direction is affected by such local anisotropy, and the magnetization also takes on various directions at different locations. That is, magnetic domain subdivision becomes possible. As a result, the eddy current loss can be reduced.

Thus, it is important to control the adhesive stress generated in the amorphous alloy ribbons to a certain level or higher.

In addition, by understanding the allowable limits of the stress, useful knowledge can be obtained in selecting the resin that can be used to reduce iron loss. This adhesive stress is due to three factors: the decrease in volume during curing, the difference in coefficient of thermal expansion between the amorphous alloy ribbons and the adhesive when heated and bonded, and the modulus of elasticity of the adhesive, and varies depending on the type of the resin that makes up the adhesive. In other words, it was found that the magnetic properties, particularly the iron loss Pcm and the eddy current loss Pe, can vary significantly depending on the type of the resin layer for lamination. The iron loss Pcm represents the iron loss at a frequency of 2000 Hz and a maximum magnetic flux density of 1.0 T (hereinafter, denoted by Pcm_{10/2000}) [W/kg], and the eddy current loss Pe represents the eddy current loss at a frequency of 2000 Hz and a maximum magnetic flux density of 1.0 T (hereinafter, denoted by Pe_{10/2000}) [W/kg]. Based on this finding, the inventors have devised a novel magnetic material.

That is, the present invention provides a laminated magnetic material including a plurality of quenched alloy strips and a resin layer made of resin and disposed between the quenched alloy strips, and in the laminated magnetic material, the adhesive stress σ acting from the resin to the quenched alloy strips is 1.8 MPa or more.

The resin of the present invention is preferably thermosetting resin. The reason is that thermosetting resin has the characteristic of being higher in heat resistance than thermoplastic resin. Furthermore, in the present invention, the adhesive stress σ is required to be 1.8 MPa or more. The reason is that by setting the adhesive stress σ to 1.8 MPa or more, the magnetic domain of the quenched alloy strips can be sufficiently subdivided, making it possible to reduce eddy current loss.

Hereinafter, embodiments of the laminated magnetic material and the method for manufacturing the laminated magnetic material of the present invention will be described in detail with reference to the drawings.

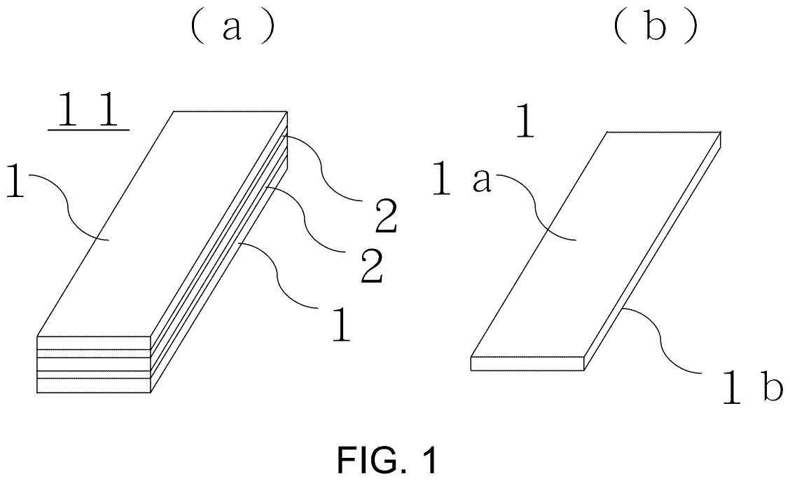

First, an embodiment of the laminated magnetic material of the present invention will be described. (a) in FIG. 1 is a schematic perspective view showing an embodiment of the laminated magnetic material of this embodiment. The laminated magnetic material 11 of this embodiment includes a plurality of quenched alloy strips 1 and a resin layer 2 disposed between the plurality of quenched alloy strips 1. It should be noted that the shapes in the drawings are shown schematically and do not necessarily correspond to the actual dimensions. (b) in FIG. 1 is a schematic perspective view showing an embodiment of the quenched alloy strip 1, which has two opposing main surfaces 1a and 1b.

### [Quenched Alloy Strip]

The material of the quenched alloy strip 1 constituting the laminated magnetic material 11 of this embodiment is not particularly limited, but may be, for example, a non-crystalline alloy strip (amorphous alloy strip) and an Fe-based amorphous alloy strip such as 2605HBIM (registered trademark) manufactured by Hitachi Metals, Ltd.

The width of the quenched alloy strip 1 is not particularly limited, but may be, for example, 100 mm or more. More preferably, the width of the ribbon is 125 mm or more. On the other hand, the upper limit of the width of the ribbon is not particularly limited, but, for example, if the width exceeds 300 mm, it may not be possible to obtain a ribbon with a uniform thickness in the width direction, and as a result, the ribbon may become partially embrittled due to the non-uniform shape. More preferably, the width of the ribbon is 275 mm or less.

The thickness of the quenched alloy strip 1 is preferably 10 μm or more and 50 μm or less. If the thickness is less than 10 μm, the mechanical strength of the quenched alloy strip 1 tends to be insufficient. The thickness is more preferably 15 μm or more, and even more preferably 20 μm or more. On the other hand, if the thickness of the ribbon exceeds 50 μm, it tends to become difficult to stably obtain an amorphous phase. The thickness is more preferably 35 μm or less, and even more preferably 30 μm or less.

Since the quenched alloy strip 1 has no anisotropy due to the crystal structure and there are no grain boundaries that impede the movement of the magnetic domain wall, the quenched alloy strip 1 has excellent soft magnetic properties including high permeability and low loss while having a high magnetic flux density.

The quenched alloy strip 1 can be manufactured by various known methods. For example, a molten alloy having the above-mentioned composition is prepared, the molten alloy is ejected onto the surface of a chill roll to form a film of the molten alloy on the surface of the chill roll, and the quenched alloy strip 1 formed on the surface is peeled off from the surface of the chill roll by blowing a peeling gas, and wound up into a roll shape by a take-up roll.

The quenched alloy strip 1 is effective as a ribbon for a motor when heat-treated at a high temperature that does not cause crystallization in order to eliminate strain that occurs during casting. As a method for obtaining such a quenched alloy strip, in the case of heat treatment, for example, a method of heat-treating in a tensioned state (tension annealing), or a method of heat-treating in a state where a magnetic field is applied in the strip longitudinal direction, a method of heat-treating in a state where a magnetic field is applied in the strip longitudinal direction while tensioning, etc. is preferable. The resin layer 2 may be formed on the quenched alloy strip 1 that has been subjected to such heat treatment, and another quenched alloy strip 1 may be joined to the resin layer 2 to form the laminated magnetic material 11.

### [Resin Layer]

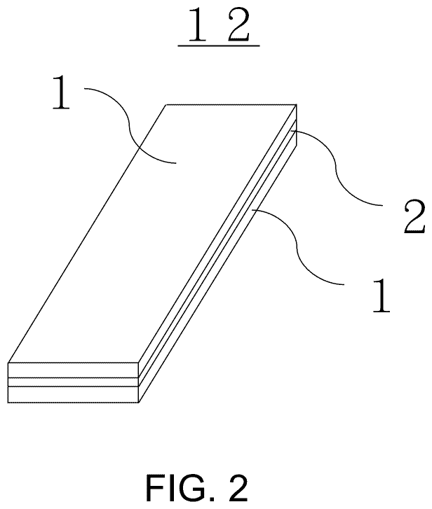

The resin layer 2 of the laminated magnetic material 11 of this embodiment is disposed on at least one of the two main surfaces 1a and 1b of the quenched alloy strip 1. FIG. 2 is a schematic perspective view showing a laminated magnetic material 12 in which the resin layer 2 is disposed between two quenched alloy strips 1. Here, the resin constituting the resin layer 2 is preferably formed using thermosetting resin, in which the adhesive stress σ [MPa] calculated by the above-mentioned Equation 1 is 1.8 MPa or more where the modulus of elasticity of the resin is denoted by γ [MPa], the coefficient of linear expansion of the resin is denoted by α1 [1/K], the curing temperature of the resin is denoted by Ta [K], the coefficient of linear contraction of the resin during curing is denoted by β, the coefficient of linear expansion of the quenched alloy ribbons is denoted by α2 [1/K], the room temperature is denoted by RT (=296 K), and the coefficient of linear contraction of the resin during curing is denoted by β.

Here, the physical properties of the resin used in calculating the adhesive stress are as follows.

The modulus of elasticity γ [MPa] of the resin is the flexural modulus at room temperature (=296 K). The flexural modulus is measured by performing a three-point bending test, using a measuring device in accordance with JIS K7171, on a rectangular (strip-shaped) test piece with a thickness T of 2 mm, a width W of 25 mm, and a length L of 40 mm, which was made by pouring resin into a rectangular (strip-shaped) mold and curing the resin. The distance L between the supports is 30 mm when the flexural modulus of the resin exceeds 700 MPa, 14 mm when the flexural modulus is 70 MPa or more and 700 MPa or less, and 8 mm when the flexural modulus is less than 70 MPa. The test speed is 0.48 mm/min, and the load F [N] continuously applied to the sample and the deflection D [mm] at that time are measured until the bending strain & derived from the following Equation 2 exceeds 0.0025. The bending stress t and the bending strain & are calculated from the measured load and deflection using the following equations (Equation 2 and Equation 3) to obtain a stress-strain curve. A linear regression is performed by the least squares method on the stress curve in the bending strain range of 0.0005≤ϵ≤0.0025 of the stress-strain curve, and the slope is regarded as the flexural modulus [MPa].

$$ε = ( 6 \times T / {L}^{2} ) \times D \qquad [ Equation 2 ]$$

$$τ = ( 3 \times F \times L ) / ( 2 \times W \times {T}^{2} ) \qquad [ Equation 3 ]$$

The coefficient of linear expansion α1 [1/K] of the resin at room temperature is measured using a thermomechanical analyzer (TMA). The coefficient of linear contraction β of the resin during curing is calculated from the relative density sg1 of the uncured resin and the relative density sg2 of the resin cured product using the following equation.

$$β = ( 1 - ( sg 1 / sg 2 ) ) / 3 \qquad [ Equation 4 ]$$

In addition, the relative density of the uncured resin and the relative density of the resin cured product are measured in accordance with the relative density cup method of JIS K6833 and the underwater substitution method of JIS K7122. In the case of a two-component adhesive, the uncured relative density sg is calculated by the following method. If the two-component adhesive is designated as agent A and agent B, the relative density sga of agent A when uncured and the relative density sgs of agent B when uncured are measured using the relative density cup method of JIS K6833. The masses of agent A and agent B to be mixed (the mass MA of agent A and the mass MB of agent B) are determined based on the recommended mixing mass ratio of the two-component adhesive, and calculated according to the following equation.

$$s g = ( {M}_{A} + {M}_{B} ) / ( {M}_{A} / {sg}_{A} + {M}_{B} / {sg}_{B} ) \qquad [ Equation 5 ]$$

If the adhesive stress σ of the resin is 1.8 MPa or more, a laminated magnetic material for a motor that has good magnetic properties with a Pcm_{10/2000} of 13.0 W/kg or less can be obtained.

If the magnitude σ of the adhesive stress is 1.8 MPa or more, a magnetic material having the above-mentioned good magnetic properties can be obtained regardless of the composition of the resin. However, it is unavoidable that the temperature of the motor core rises during use. Generally, thermoplastic resin has lower heat resistance than thermosetting resin. Thus, there are concerns about the long-term reliability of thermoplastic resin. Therefore, it is desirable to use thermosetting resin that has excellent heat resistance. Furthermore, the glass transition temperature of the resin cured product is preferably 90° C. or higher. Thermosetting resin is a liquid compound with a relatively low molecular weight before reaction. However, when heated, mixed with a curing agent, reacted with a catalyst, irradiated with ultraviolet light, exposed to moisture in the air, blocked by oxygen, or exposed to active metals, polymerization reaction begins and the molecular chains are crosslinked in three dimensions, causing the resin to cure and become a solid polymer compound. In particular, epoxy resin is the most widely used thermosetting resin, and is particularly preferred for there are many types available and epoxy resin is highly practical, also from an economical standpoint.

Regarding the thickness of the resin layer 2, since it is important to increase the lamination factor as much as possible in order to achieve excellent magnetic properties of the laminate, for example, the thickness is preferably about 1.0 to 6.0 μm, and preferably 1.0 to 3.0 μm in order to further increase the lamination factor.

The resin layer 2 is preferably bonded to at least one of the main surfaces la and 1b of the quenched alloy strip 1 so as not to peel off easily. The resin layer 2 may be disposed on each of the two main surfaces 1a and 1b of the quenched alloy strip 1. The resin layer 2 may be disposed over the entire main surfaces 1a and 1b, or may be provided in a predetermined pattern, such as a stripe pattern or a dot pattern, on the main surfaces 1a and 1b, including a region where the resin layer 2 is disposed and a region where the resin layer 2 is not disposed.

A method for manufacturing the laminated magnetic material according to this embodiment is a method for manufacturing a laminated magnetic material that includes a plurality of quenched alloy strips and a resin layer made of resin and disposed between the quenched alloy strips. The method includes a step of applying the resin, and a step of curing the resin by laminating the quenched alloy strips, in which the adhesive stress σ [MPa] represented by the above-mentioned equation (Equation 1) is 1.8 MPa or more where the modulus of elasticity of the resin at room temperature is denoted by γ [MPa], the coefficient of linear expansion of the resin at room temperature is denoted by α1 [1/K], the curing temperature of the resin is denoted by Ta [K], the coefficient of linear contraction of the resin during curing is denoted by β, the thickness of the resin is denoted by h1 [μm], the thickness of the quenched alloy strips is denoted by h2 [μm], the coefficient of linear expansion of the quenched alloy strips is denoted by α2 [1/K], and the room temperature is denoted by RT.

The step of applying resin is a step of disposing resin on one or both surfaces of the quenched alloy strip 1 to form the resin layer 2. The method for forming the resin layer 2 is not particularly limited, but, for example, there are a method of applying resin by flexographic printing and a method of preparing an adhesive containing resin and a solvent, applying the adhesive with a spray or coater, and then evaporating the solvent.

In the case where the resin layer 2 is formed by applying resin using flexographic printing, this method is often used when applying thermosetting resin that does not contain a solvent. In other words, the thermosetting resin is applied to one surface of the quenched alloy strip 1 by flexographic printing, another quenched alloy strip 1 is placed on the one surface of the quenched alloy strip 1 applied with the thermosetting resin, and the two quenched alloy strips 1 are press-bonded by a roller or the like. Thereafter, the thermosetting resin is heated up to the curing temperature to be cured, thereby forming the laminated magnetic material 11 for a motor.

The step of curing resin is a step in which, after the step of applying resin, another quenched alloy strip 1 is placed on the surface of the quenched alloy strip 1 applied with the resin, the two quenched alloy strips 1 are press-bonded by a roller or the like, and then the resin is heated up to the curing temperature to be cured.

### EXAMPLES

The quenched alloy strip 1 was prepared using the 2605HBIM material manufactured by Hitachi Metals, Ltd. with a length of 120 mm, a width of 25 mm, and a thickness of 25 μm. Here, the coefficient of linear expansion of 2605HB1M was 4.3×10⁻⁶ [1/K].

Further, it was confirmed that the magnetic properties of the quenched alloy strip, that is, Pcm_{10/2000} and Pe_{10/2000}, were set so that Pcm_{10/2000}=13.9 [W/kg] and Pe_{10/2000}=10.5 [W/kg].

Two sheets of the above-mentioned quenched alloy strip were bonded using resins having various adhesive stresses to manufacture the laminated magnetic materials for a motor as examples and comparative examples, and the Pcm_{10/2000} and Pe_{10/2000} of each laminated magnetic material were measured.

Here, seven types of resins a1, b1, c1, d1, e1, f1, and g1 were prepared. Resins a1, b1, c1,and d1 were used in the examples, and resins e1 and f1 were used in the comparative examples. Table 1 shows the curing type, durometer hardness, glass transition temperature, and curing temperature of each resin, and Table 2 shows the thickness, modulus of elasticity, thermal contraction rate, coefficient of linear contraction during curing, and adhesive stress of the resin layer at the time of sample preparation. Here, the modulus of elasticity, coefficient of linear expansion, and coefficient of linear contraction during curing were based on the results measured by the above-mentioned measuring methods. In addition, the thermal contraction rate δ is represented by the following equation 5 where the coefficient of linear expansion of the resin is denoted by α1, the curing temperature of the resin is denoted by Ta, the coefficient of linear expansion of the quenched alloy strip is denoted by α2, and the room temperature is denoted by RT (=296 K).

$$δ = ( α1 - α2 ) ( T a - R T ) \qquad [ Equation 6 ]$$

Here, the coefficient of linear expansion α2 of the quenched alloy strip was 4.3×10⁻⁶ [1/K].

Regarding the curing type, there are a one-component type that already contains a curing agent and cures by heating, and a two-component type that cures by mixing a curing agent and a main agent when used.

Durometer hardness is the hardness measured by pressing a type D (A) shaped indenter against the surface of a test piece with a specified spring force using a durometer hardness tester (rubber hardness tester), and obtained from the indentation depth of the indenter at that time, and refers to a value measured by the test method specified in JIS K7215.

The adhesive stress σ [MPa] is a value calculated from the above-mentioned equation (Equation 1), with the coefficient of linear expansion of the quenched alloy strip being 4.3×10⁻⁶ [1/K] and the room temperature being 296 [K], using the modulus of elasticity, coefficient of linear expansion, coefficient of linear contraction during curing, and curing temperature of each resin in

Table 1.

TABLE 1

| | | | | | Glass | |
|---|---|---|---|---|---|---|
| | | | | | transition | Curing |
| | | | | Durometer | temperature | temperature |
| Sample | Resin | Component | Curing type | hardness | (° C.) | (° C.) |
| Example 1 | a1 | Epoxy | One-component | — | 177 | 180 |
| Example 2 | b1 | Epoxy | One-component | — | 205 | 150 |
| Example 3 | c1 | Epoxy | One-component | D84 | 151 | 150 |
| Example 4 | d1 | Epoxy | One-component | D84 | 91 | 120 |
| Example 5 | a1 | Epoxy | One-component | — | 177 | 180 |
| Example 6 | b1 | Epoxy | One-component | — | 205 | 150 |
| Example 7 | c1 | Epoxy | One-component | D84 | 151 | 150 |
| Comparative | e1 | Epoxy, modified | Two-component | A72 | −64.7 | Room |
| Example 1 | | silicone | | | | temperature |
| Comparative | f1 | Epoxy | Two-component | D76 | 70 | Room |
| Example 2 | | | | | | temperature |
| Comparative | g1 | Epoxy | Two-component | D76 | 70 | 60 |
| Example 3 | | | | | | |

TABLE 2

| | | | | | Coefficient of | |
|---|---|---|---|---|---|---|
| | Resin layer | Modulus of | Coefficient of | Thermal | linear contraction | Adhesive |
| | thickness | elasticity | linear expansion | contraction | β during curing | stress σ |
| Sample | (μm) | (MPa) | α1 (10⁻⁶/K) | rate δ (%) | (%) | (MPa) |
| Example 1 | 2.3 | 2930 | 60 | 0.874 | 0.730 | 2.16 |
| Example 2 | 5.3 | 2900 | 60 | 0.707 | 1.18 | 5.80 |
| Example 3 | 4.9 | 2750 | 67 | 0.796 | 1.94 | 7.39 |
| Example 4 | 4.0 | 2600 | 78 | 0.715 | 0.610 | 2.76 |
| Example 5 | 6.7 | 2930 | 60 | 0.874 | 0.730 | 6.30 |
| Example 6 | 5.3 | 2900 | 60 | 0.707 | 1.18 | 3.17 |
| Example 7 | 3.5 | 2750 | 67 | 0.796 | 1.94 | 5.28 |
| Comparative | 3.2 | 11.9 | 153 | 0 | 0.741 | 0.0564 |
| Example 1 | | | | | | |
| Comparative | 2.1 | 1450 | 70 | 0 | 0.499 | 0.304 |
| Example 2 | | | | | | |
| Comparative | 1.9 | 1450 | 70 | 0.232 | 0.499 | 0.403 |
| Example 3 | | | | | | |

### [Preparation of Sample]

First, resins a1 to g1 shown in Table 1 and Table 2 were applied to the entire surface of the quenched alloy strip using flexographic printing, and another quenched alloy strip was placed thereon and press-bonded by a roller. Here, for the two-component type resin, the curing agent and the main agent were mixed until uniformity was reached, and then applied by flexographic printing. After press-bonding, the resins were heated at the respective curing temperatures to be cured, or left at room temperature for room temperature curing, thereby preparing the samples of Examples 1 to 4 and Comparative Examples 1 to 3. Further, a sample was prepared as

Comparative Example 7 in which two quenched alloy strips were laminated under their own weights without forming a resin layer.

Furthermore, the quenched alloy strip 1 was heat-treated while receiving tension in the longitudinal direction of the quenched alloy strip 1 (hereinafter referred to as tension annealing), and two sheets of the quenched alloy strips 1 that had been subjected to the tension annealing were bonded using resins a1, b1, and c1 in Table 1 to prepare samples as Examples 5, 6, and 7. In addition, samples bonded using resins e1, f1, and g1 in Table 1 were prepared as Comparative Examples 4, 5, and 6. Specifically, before bonding, tension annealing was performed by applying tension of 40 MPa in the longitudinal direction of the quenched alloy strip 1 and carrying out heat treatment at 450° C., thereby imparting induced magnetic anisotropy such that the direction becomes the direction of easy magnetization. For the two sheets of quenched alloy strips that had been subjected to tension annealing, as in Examples 1 to 3 and Comparative Examples 1 to 3 prepared using resins a1, b1, c1, e1, f1, and g1 in Table 1, the resin was applied to the entire surface of the quenched alloy strip by flexographic printing, and the other quenched alloy strip 1 was placed thereon and press-bonded by a roller. Then, the resin was heated to the curing temperature and cured to prepare Examples 5 to 7 and Comparative Examples 4 to 6. In addition, a sample was prepared as Comparative Example 8 in which two sheets of the quenched alloy strips that had been subjected to tension annealing were laminated under their own weights without forming a resin layer.

As can be seen from Table 2, the thickness of the resin layer 2 after curing was from 2.3 μm to 5.3 μm in Examples 1 to 7, and from 1.9 μm to 4.9 μm in Comparative Examples 1 to 6.

### (Magnetic Properties)

The Pcm_{10/2000} of the prepared sample was measured. For Pcm_{10/2000,} each sample was excited at a frequency of 2000 Hz and a maximum magnetic flux density of 1.0 T, and the iron loss (W/kg) at that time was measured.

Here, the magnitude of Pe_{10/2000} was calculated by the following method.

The maximum magnetic flux density Bm was kept constant at 1 T, and the iron loss Pcm was measured at each frequency f=50, 100, 200, 400, 500, 700, 1000, and 2000 Hz. Next, the iron loss Pcm at each frequency was divided by that frequency to calculate the iron loss per cycle Pcm/f [W/kg/Hz]. This Pcm/f satisfies Pcm/f=Ke×f^{0.5}+Kh. Here, Ke is a coefficient relating to eddy current loss, and Kh is hysteresis loss in the case of DC.

Ke and Kh were calculated by performing linear approximation by the least squares method using the Pcm/f at each frequency calculated above and f^{0.5} at that time. Since the eddy current loss at each frequency can be calculated by Ke×f^{1.5}, the eddy current loss Pe_{10/2000} was calculated by Ke×2000^{1.5}.

For each measurement, an AC magnetic property measuring device, BH loop analyzer SY8218, manufactured by Iwatsu Electric Co., Ltd. was used, and an amplifier, SY-5001, manufactured by PMK Corporation was used. In addition, a measurement frame was prepared and used as a measurement jig with reference to JIS C2556 “Methods of measurement of the magnetic properties of electrical steel strip and sheet by means of a single sheet tester.” The configuration of the jig is composed of MnZn ferrite yokes, a resin bobbin, and a polyurethane-coated copper wire. The primary winding (excitation coil) (wire diameter 0.5 mm) and the secondary winding (B coil) (wire diameter 0.5 mm) were wound on the resin bobbin using the polyurethane-coated copper wire with 57 and 100 turns, respectively, a ribbon was inserted between the bobbin, and a magnetic field was applied to the ribbon over a bobbin length of 36.2 mm. At the time of measurement, the measurement was performed by sandwiching the quenched alloy strip 1 between the upper and lower MnZn ferrite yokes. By sandwiching the quenched alloy strip 1 between the MnZn ferrite yokes, the flow of magnetic flux becomes a closed magnetic circuit, making it possible to prevent the generation of a demagnetizing field in the quenched alloy strip 1. In addition, the background caused by the MnZn ferrite yokes and the gap between the coil and the magnetic material was corrected by connecting a compensation coil between the jig and SY8218 and adjusting the number of turns of the compensation coil so that the output when no sample was present during application of a magnetic field of 8000 A/m was zero.

Table 3 shows the measurement result for each sample.

TABLE 3

| | | Adhesive | Modulus of | | |
|---|---|---|---|---|---|
| | | stress σ | elasticity | Pcm_{10/2000} | Pe_{10/2000} |
| Sample | Resin | (MPa) | (MPa) | (W/kg) | (W/kg) |
| Example 1 | a1 | 2.16 | 2930 | 12.0 | 7.93 |
| Example 2 | b1 | 5.80 | 2900 | 11.4 | 6.40 |
| Example 3 | c1 | 7.39 | 2750 | 11.7 | 5.93 |
| Example 4 | d1 | 2.76 | 2600 | 13.0 | 9.44 |
| Example 5 | a1 | 6.30 | 2930 | 10.1 | 5.55 |
| Example 6 | b1 | 3.17 | 2900 | 9.55 | 4.74 |
| Example 7 | c1 | 5.28 | 2750 | 8.71 | 4.88 |
| Comparative | e1 | 0.00564 | 11.9 | 14.0 | 11.8 |
| Example 1 | | | | | |
| Comparative | f1 | 0.304 | 1450 | 14.4 | 11.6 |
| Example 2 | | | | | |
| Comparative | g1 | 0.403 | 1450 | 13.2 | 9.64 |
| Example 3 | | | | | |
| Comparative | e1 | 0.00335 | 11.9 | 22.9 | — |
| Example 4 | | | | | |
| Comparative | f1 | 0.593 | 1450 | 18.6 | — |
| Example 5 | | | | | |
| Comparative | g1 | 1.04 | 1450 | 13.9 | 13.1 |
| Example 6 | | | | | |
| Comparative | — | 0 | 0 | 14.2 | 11.8 |
| Example 7 | | | | | |
| Comparative | — | 0 | 0 | 21.7 | — |
| Example 8 | | | | | |

As can be seen from Table 1, Table 2, Table and 3, Examples 1 to 7 having adhesive stress of 1.8 MPa or more had a Pcm_{10/2000} of 13.0 [W/kg] or less, and had good iron loss characteristics for use in high-speed rotating motors of 5000 rpm or more. In particular, compared to Comparative Example 7 where no bonding was performed, the iron loss is smaller by about 8 to 39%. Moreover, the Pe_{10/2000} of Examples 1 to 7 is a very small value compared to Comparative Examples 1 to 3, and the adhesive stress is 2.0 MPa or more, making it possible to sufficiently subdivide the magnetic domain of the quenched alloy strip 1. Here, it was found that, in the case where a resin having a modulus of elasticity of 2600 MPa or more was used as in

Examples 1 to 7, good magnetic properties were obtained. In particular, it was found that, in the case where a resin having a modulus of elasticity of 2700 MPa or more was used, better magnetic properties were obtained. Furthermore, it can be seen from Table 1 and Table 2 that the coefficient of linear contraction of the resin during curing is preferably 0.6% or more. It is also found that the thermal contraction rate 8 of the resin is preferably 0.7% or more.

As can be seen from Table 3, Examples 5, 6, and 7, which used the quenched alloy strip 1 subjected to tension annealing, showed a further reduction in Pcm10/2000 of about 15% or more and a reduction in Pe10/2000 of about 17% or more compared to Examples 1, 2, and 3, which used the same resins a1, b1, and c1, and showed good iron loss characteristics.

Here, for the quenched alloy strips 1 that used resin c1, had no heat treatment, and had tension annealing treatment, laminated magnetic materials were prepared by the same method as in Example 7 using the same resin c1 by changing the resin thickness. Then, for the laminated magnetic materials having a resin thickness of 1.2 μm or more, the laminated magnetic materials using the quenched alloy strip 1 that had no heat treatment were used as Examples 8 to 12, and the laminated magnetic materials using the quenched alloy strip 1 subjected to tension annealing treatment were used as Examples 13 to 17. Further, for the laminated magnetic materials having a resin thickness of less than 1.2 μm, a laminated magnetic material using the quenched alloy strip 1 that had no heat treatment was used as Comparative Example 9, and a laminated magnetic material using the quenched alloy strip 1 subjected to tension annealing treatment was used as Comparative Example 10. Then, for all the prepared samples, the Pcm_{10/2000} and Pe_{10/2000} of the two-layer laminate were measured, and the results are shown in Table 4.

TABLE 4

| | Whether | | | | |
|---|---|---|---|---|---|
| | heat | Resin | Adhesive | | |
| | treatment | thickness | stress σ | Pcm_{10/2000} | Pe_{10/2000} |
| Sample | is applied | (μm) | (MPa) | (W/kg) | (W/kg) |
| Example 8 | No | 4.36 | 6.57 | 11.0 | 5.94 |
| Example 9 | No | 2.17 | 3.27 | 11.0 | 6.23 |
| Example 10 | No | 2.00 | 3.01 | 11.0 | 6.07 |
| Example 11 | No | 1.89 | 2.85 | 11.1 | 6.15 |
| Example 12 | No | 1.75 | 2.64 | 12.3 | 7.77 |
| Comparative | No | 1.06 | 1.59 | 13.1 | 8.60 |
| Example 9 | | | | | |
| Example 13 | Tension | 3.48 | 5.24 | 7.86 | 4.11 |
| | annealing | | | | |
| Example 14 | Tension | 2.53 | 3.83 | 8.80 | 4.36 |
| | annealing | | | | |
| Example 15 | Tension | 2.00 | 3.01 | 9.78 | 5.84 |
| | annealing | | | | |
| Example 16 | Tension | 1.75 | 2.64 | 8.87 | 4.95 |
| | annealing | | | | |
| Example 17 | Tension | 1.21 | 1.82 | 9.76 | 5.95 |
| | annealing | | | | |
| Comparative | Tension | 1.14 | 1.72 | 13.7 | 9.05 |
| Example 10 | annealing | | | | |

As can be seen from Table 4, it can be confirmed that as the resin thickness increases, Pcm_{10/2000} and Pe_{10/2000} tend to decrease. The reason is considered to be that, as the resin thickness increases, the adhesive stress increases, so the effect of reducing eddy current loss due to magnetic domain subdivision becomes greater. From Examples 8 to 17, it can be seen that, when the adhesive stress is 1.8 MPa or more, Pcm_{10/2000} is 13.0 [W/kg] or less, and the iron loss characteristics are good for motors rotating at high speeds of 5000 rpm or more.

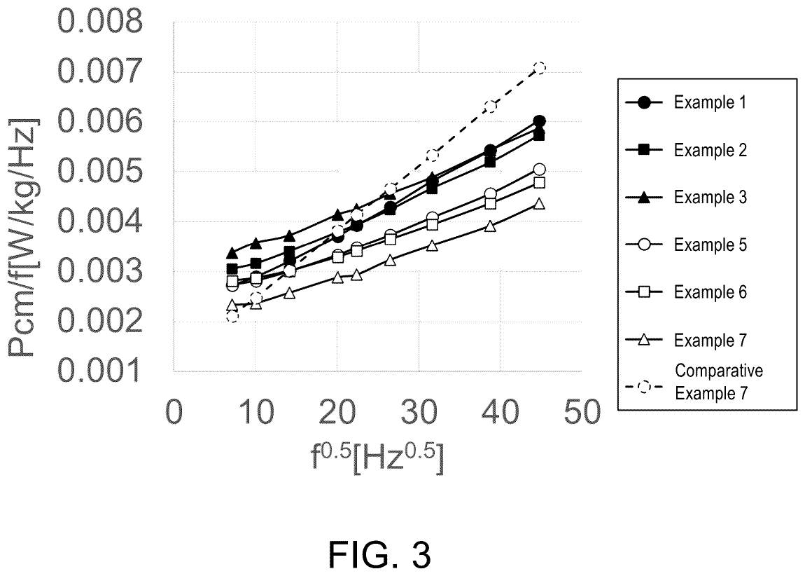

Next, for Examples 1, 2, and 3, Examples 5, 6, and 7, and Comparative Example 7, the f^{0.5} dependency of iron loss per cycle Pcm/f [W/kg/Hz] when the maximum magnetic flux density Bm=1.0 T is shown in FIG. 3. The measurement frequencies are f=50, 100, 200, 400, 500, 700, 1000, 1500, and 2000 Hz. As can be seen from FIG. 3, in Examples 1, 2, and 3, when the frequency is higher than 700 Hz, that is, when f^{0.5} is greater than 26.46, the iron loss is smaller than that in Comparative Example 7.

Furthermore, it was found from FIG. 3 that in Examples 5 and 6, when the frequency is higher than 200 Hz, that is, when f^{0.5} is greater than 14.14, and in Example 7, when the frequency is higher than 100 Hz, that is, when f^{0.5} is greater than 10.00, the iron loss is smaller than that in Comparative Example 7. Therefore, by setting the adhesive stress σ [MPa] represented by the above-mentioned Equation 1 to 1.8 MPa or more for a plurality of quenched alloy strips subjected to tension annealing, it is possible to achieve an iron loss reduction effect in a wider frequency band than ever before, where the modulus of elasticity of the resin at room temperature is denoted by γ [MPa], the coefficient of linear expansion of the resin at room temperature is denoted by α1 [1/K], the curing temperature of the resin is denoted by Ta [K], the coefficient of linear contraction of the resin during curing is denoted by β, the thickness of the resin is denoted by h1 [μm], the thickness of the quenched alloy strips is denoted by h2 [μm], the coefficient of linear expansion of the quenched alloy strips is denoted by α2 [1/K], and the room temperature is denoted by RT.

In other words, a laminated magnetic material, which includes a plurality of stretched heat-treated alloy strips (tension-annealed quenched alloy strips) and a resin layer made of resin and disposed between the stretched heat-treated alloy strips, and which is characterized in that the iron loss Pcm at a frequency of 2000 Hz and a maximum magnetic flux density of 1.0 T is 10.5 W/kg or less, reduces the effect of anisotropy resulting from tension annealing, making it possible to provide good magnetic properties for use in high-speed rotating motors of 5000 rpm or more. More preferably, the iron loss Pcm at a frequency of 2000 Hz and a maximum magnetic flux density of 1.0 T is 7.5 W/kg or more.

Next, for Example 3, Example 7, Comparative Example 7, and Comparative Example 8, the relative magnetic permeability in the longitudinal direction and the width direction of the quenched alloy strip (hereinafter referred to as the relative magnetic permeability in the ribbon longitudinal direction and the relative magnetic permeability in the ribbon width direction), and the relative magnetic permeability in the width direction relative to the relative magnetic permeability in the longitudinal direction (hereinafter referred to as the relative magnetic permeability ratio in the ribbon longitudinal direction and width direction) were calculated, respectively. The results are shown in Table 4. The relative magnetic permeability μᵣ is represented by the following Equation 7 for the maximum magnetic field Hm [A/m] when excited at a frequency of 2000 Hz and a maximum magnetic flux density Bm=1.0 T.

$${μ}_{r} = Bm / Hm / ( 4 \times π \times 1 {0}^{- 7} ) \qquad [ Equation 7 ]$$

TABLE 5

| | | | Relative magnetic |
|---|---|---|---|
| | Relative magnetic | | permeability |
| | permeability | Relative magnetic | ratio in ribbon |
| | in ribbon | permeability | longitudinal |
| | longitudinal | in ribbon width | and width |
| Sample | direction (—) | direction (—) | directions (—) |
| Example 3 | 7081 | 7626 | 0.929 |
| Example 7 | 11250 | 6949 | 1.62 |
| Comparative | 36360 | 20770 | 1.75 |
| Example 7 | | | |
| Comparative | 28607 | 10580 | 2.70 |
| Example 8 | | | |

When tension annealing is performed on the quenched alloy strip 1, the direction in which tension is applied becomes the direction of easy magnetization, and the direction perpendicular to the direction in which tension is applied becomes the direction of hard magnetization. In Comparative Example 8, the ribbon longitudinal direction is the direction of easy magnetization, and the width direction is the direction of hard magnetization. This results in a difference in magnetic permeability between the ribbon longitudinal direction and width direction, which causes anisotropy.

In motor applications, magnetic fields are applied in various directions due to the rotating magnetic field generated inside the motor, so it is generally considered preferable for the anisotropy, that is, the relative magnetic permeability ratio in the ribbon longitudinal direction and width direction, to be small. As can be seen from Table 5, Comparative Example 8 which had been subjected to tension annealing has a greater ratio of relative magnetic permeability than Comparative Example 7 which was not heat-treated, and therefore is difficult to use for a motor.

On the other hand, in Example 7 in which bonding was performed using resin c1, the ratio of relative magnetic permeability is smaller than Comparative Example 7 despite the tension annealing, and it can be said to be good for use in a motor. The reason is considered to be that the adhesive stress from the resin caused localized anisotropy at different locations, reducing the effect of anisotropy resulting from tension annealing.

Table 6 shows the relative magnetic permeability in the ribbon longitudinal direction for

Examples 5 and 6 which used resins a1 and b1 different from Example 7.

TABLE 6

| | Relative magnetic permeability in |
|---|---|
| Sample | ribbon longitudinal direction (—) |
| Example 5 | 14778 |
| Example 6 | 13051 |
| Example 7 | 11250 |
| Comparative Example 8 | 28607 |

For Examples 5 and 6, it is also considered that the adhesive stress reduces the relative magnetic permeability in the longitudinal direction to the same extent as in Example 7, and the effect of anisotropy resulting from tension annealing is reduced, making it good for use in motor applications.

In other words, a laminated magnetic material, which includes a plurality of stretched heat-treated alloy strips (tension-annealed quenched alloy strips) and a resin layer made of resin and disposed between the stretched heat-treated alloy strips, and which is characterized in that the iron loss Pcm at a frequency of 2000 Hz and a maximum magnetic flux density of 1.0 T is 10.5 W/kg or less and the relative magnetic permeability in the longitudinal direction of the stretched heat-treated alloy strips is 10,000 or more and 15,000 or less, reduces the effect of anisotropy resulting from tension annealing and has good magnetic properties for use in high-speed rotating motors of 5000 rpm or more. More preferably, the iron loss Pcm at a frequency of 2000 Hz and a maximum magnetic flux density of 1.0 T is 8.0 W/kg or more.

### (Magnetic Domain Structure)

The results of magnetic domain observation that was performed on each sample of the above-mentioned Examples 1 to 7 and Comparative Examples 1, 4, 5, 6, 7, and 8 will be described. The device used was a magnetic domain observation device manufactured by Neoark Corporation. The field of view was fixed at 14×10.5 mm², and the magnetic domain of the sample was observed using the magnetic Kerr effect while a magnetic field was applied in the longitudinal direction of the sample. The strength of the applied magnetic field was set so that the movement of the magnetic domain could be observed from a state in which the magnetization was saturated in the ribbon longitudinal direction until the magnetization was completely saturated in the opposite direction by 180°, and was set to −200, −100, −50, −25, 0, 25, 50, 100, and 200 A/m.

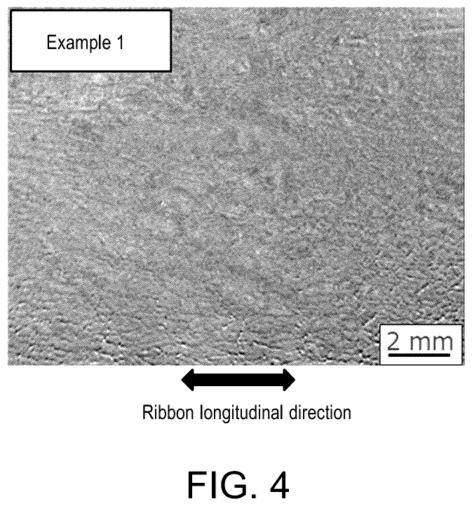

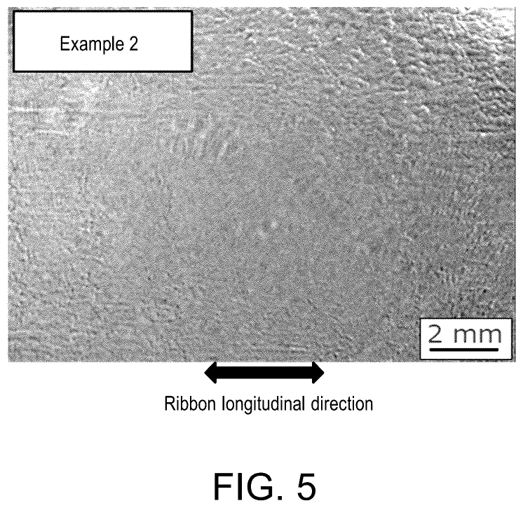

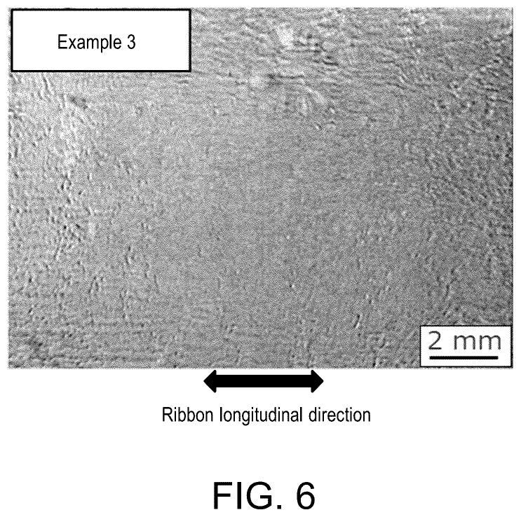

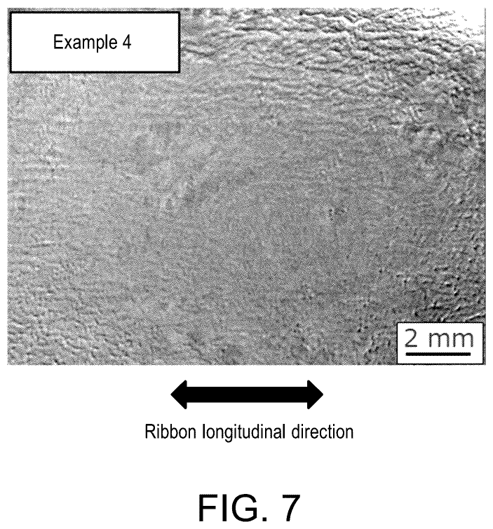

FIG. 4 to FIG. 9 show photographs of the magnetic domain structures of the samples of Examples 1 to 4 and Comparative Examples 1 and 7 when the magnetic field was 0 A/m. Here, in the magnetic domain structure photograph, the bright contrast portions (white parts) and dark contrast portions (black parts) represent magnetic domains, and the boundaries therebetween represent magnetic domain walls. In addition, the horizontal direction of the magnetic domain structure photograph represents the longitudinal direction of the quenched alloy strip 1.

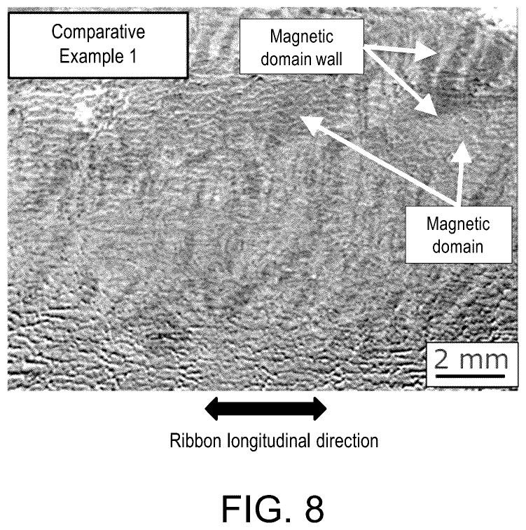

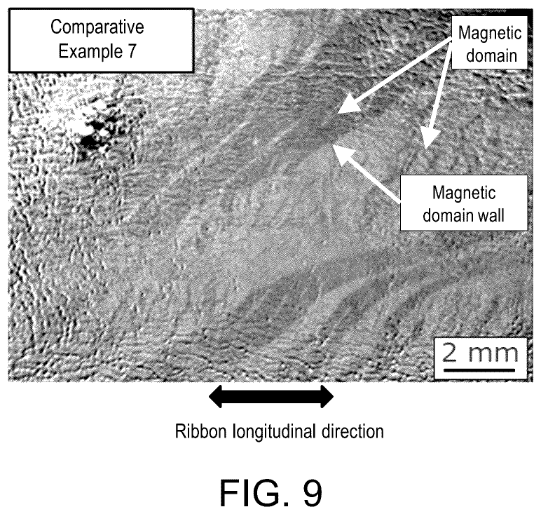

In Comparative Examples 1 and 7 (FIG. 8 and FIG. 9), magnetic domains inherent to the quenched alloy strip were observed all over the image. At this time, the magnetic domain width was about 2 mm or more at the largest. On the other hand, in Examples 1 to 4 (FIG. 4 to FIG. 7) in which the adhesive stress was 1.8 MPa or more, the magnetic domains as seen in Comparative Examples 1 and 7 were no longer observed, and no magnetic domain walls could be observed either. Therefore, it is considered that the adhesive stress of 1.8 MPa or more changed the magnetic domain structure, and the magnetic domains were subdivided to the point where the magnetic domains were no longer observable, which as a result contributed to a reduction in eddy current loss and enabled low iron loss characteristics to be exhibited in a high-frequency band.

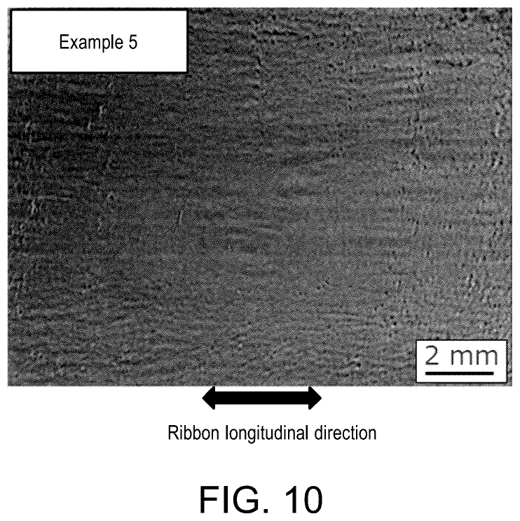

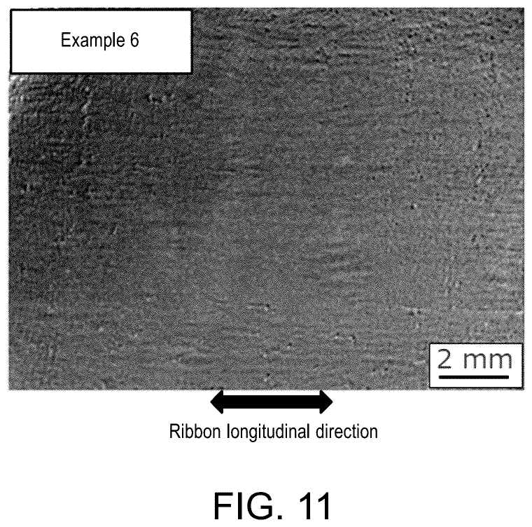

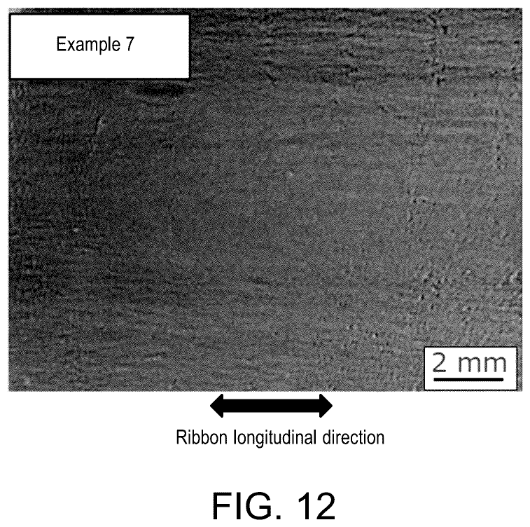

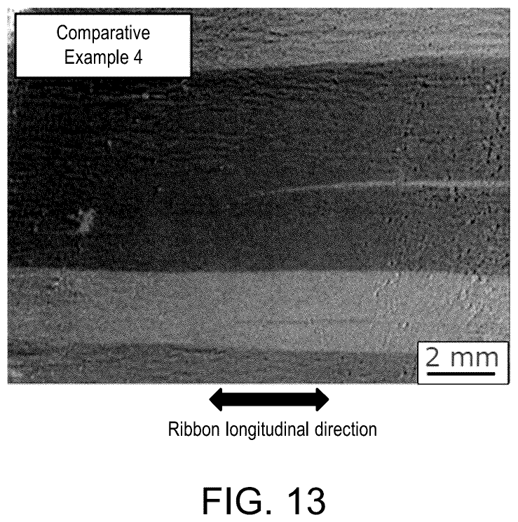

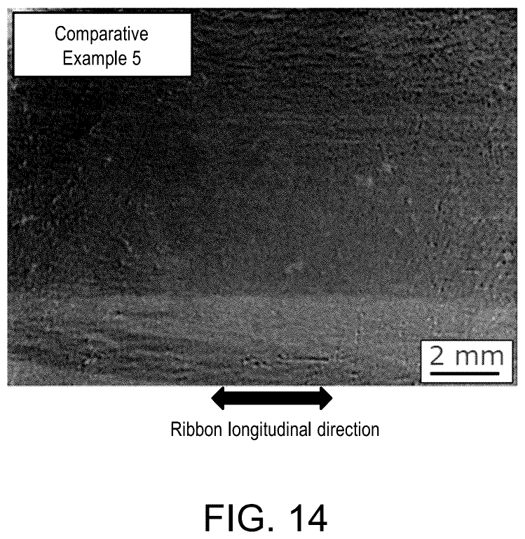

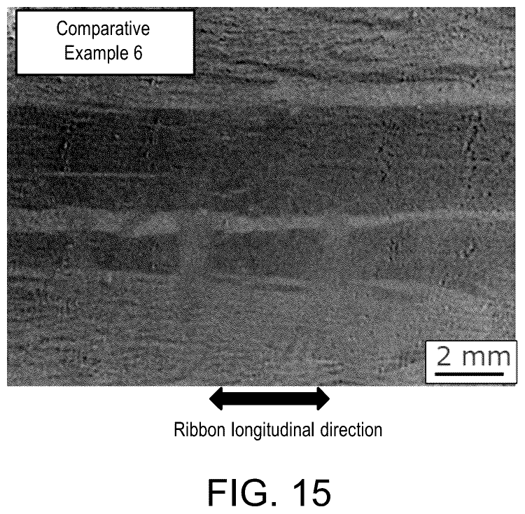

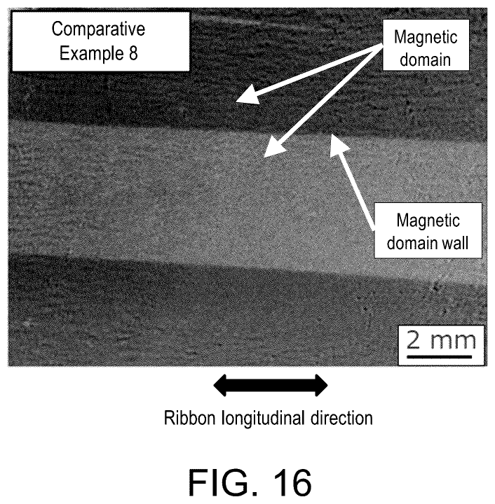

FIG. 10 to FIG. 16 show photographs of the magnetic domain structures of the samples of Examples 5 to 7 and Comparative Examples 4, 5, 6, and 8 when the magnetic field was 0 A/m. In Comparative Examples 4, 5, 6, and 8 of FIG. 13 to FIG. 16, magnetic domains having magnetic domain walls oriented in the longitudinal direction (180° magnetic domain walls) resulting from tension annealing were observed. At this time, the magnetic domain width was about 2 mm or more, and about 6 mm at the largest. On the other hand, when the adhesive stress was 1.8 MPa or more as in Examples 5 to 7 (FIG. 10 to FIG. 12), the magnetic domains oriented in the longitudinal direction were disturbed, the magnetic domains as in Comparative Example 8 were no longer observed, and no magnetic domain walls could be observed either. Therefore, it is considered that the adhesive stress of 1.8 MPa or more changed the magnetic domain structure, and the magnetic domains were subdivided to the point where the magnetic domains were no longer observable, which as a result contributed to a reduction in eddy current loss and enabled low iron loss characteristics to be exhibited in a high-frequency band.

Furthermore, for Examples 5 to 7 and Comparative Examples 4, 5, 6, and 8 using the quenched alloy strips subjected to tension annealing, image analysis was performed on the magnetic domain images of the samples under each magnetic field condition (−200, −100, −50, −25, 0, 25, 50, 100, 200 A/m) to extract the feature amounts and confirm the relationship with the adhesive stress.

The method of the image analysis for the magnetic domain images is shown below.

First, the image was converted into a grayscale image, and the brightness value of each pixel was obtained by setting the minimum brightness value to 0 and the maximum brightness value to 255. The image data at this time became matrix data of the number of vertical pixels and the number of horizontal pixels of the image, with the top left pixel of the image as the origin (first row, first column). In the case of this image analysis, the vertical pixels was 768 and the number of horizontal pixels was 1024, resulting in matrix data of 768 rows×1024 columns.

Next, the average value of all the brightness data in the first row was taken, and the same processing was performed for each row. Next, the row number of each row was defined as the x component and the average brightness value of each row was defined as the y component to create point cloud data in which (x, y)=(row number, average brightness value). A linear regression was performed on this point cloud data using the least squares method to calculate an approximate straight line.

Then, the y′ component was obtained by substituting the x component of each point into the above-mentioned approximate straight line, and the residual between the y component and the y′ component of each point was obtained. The standard deviation of the residual of each obtained point was calculated, and this was taken as the feature amount in the row direction, which was designated as sigma_h. For each sample, sigma_h was calculated under each magnetic field condition (−200, −100, −50, −25, 0, 25, 50, 100, 200 A/m).

Furthermore, the same processing as that in the row direction was performed in the column direction. In other words, the average value of all the brightness data in the first column was taken, and the same processing was performed for each column. Next, the column number of each column was defined as the x component and the average brightness value of each column was defined as the y component to create point cloud data in which (x, y)=(column number, average brightness value). A linear regression was performed on this point cloud data using the least squares method to calculate an approximate straight line. Then, the y′ component was obtained by substituting the x component of each point into the above-mentioned approximate straight line, and the residual between the y component and the y′ component of each point was obtained. The standard deviation of the residual of each obtained point was calculated, and this was taken as the feature amount in the column direction, which was designated as sigma_w. For each sample, sigma_w was calculated under each magnetic field condition (−200, −100, −50, −25, 0, 25, 50, 100, 200 A/m).

For each sample, the ratio of sigma_h to sigma_w under each magnetic field condition, sigma_h/sigma_w, was calculated, among which the largest sigma_h/sigma_w was taken as the feature amount of the magnetic domain image and was designated as (sigma_h/sigma_w)_max. Table 6 shows the relationship between the (sigma_h/sigma_w)_max value and the adhesive stress for each sample.

TABLE 7

| | Adhesive stress | |
|---|---|---|
| Sample | σ (MPa) | sigma_h/sigma_w_max (—) |
| Example 5 | 6.30 | 3.21 |
| Example 6 | 3.17 | 1.98 |
| Example 7 | 5.28 | 3.15 |
| Comparative Example 4 | 0.00335 | 14.9 |
| Comparative Example 5 | 0.593 | 14.0 |
| Comparative Example 6 | 1.04 | 9.90 |
| Comparative Example 8 | 0 | 13.7 |

As can be seen from Table 7, in Comparative Examples 4, 5, 6, and 8 in which no bonding was performed, magnetic domains with 180° magnetic domain walls oriented in the longitudinal direction resulting from tension annealing are observed, so the above-mentioned magnetic domains are observed while changing the magnetic field from −200 A/m to 200 A/m, the difference in contrast between the magnetic domains that are white portions and the magnetic domains that are black portions increases, and (sigma_h/sigma_w)_max takes a large value.

On the other hand, in Examples 5, 6, and 7, the adhesive stress is large, the magnetic domains are subdivided, and the difference in contrast between the magnetic domains that are white portions and the magnetic domains that are black portions decreases, so (sigma_h/sigma_w)_max becomes small.

The feature amount of the magnetic domain image, (sigma_h/sigma_w)_max, is a measure of the degree to which the magnetic domains oriented in the longitudinal direction resulting from tension annealing are subdivided, and when (sigma_h/sigma_w)_max is 4 or less, the magnetic domains are subdivided by the large adhesive stress, so the eddy current loss is reduced and low iron loss characteristics are exhibited in a high-frequency band, making it possible to obtain good magnetic properties.

Thus, according to this embodiment, it is possible to provide a laminated magnetic material for a motor that is excellent in heat resistance and has low iron loss characteristics in a high-frequency band, and a method for manufacturing the laminated magnetic material for a motor.

Although the present invention has been described above using the above-mentioned embodiments, the technical scope of the present invention is not limited to the above-mentioned embodiments.

### REFERENCE SIGNS LIST

1 quenched alloy strip
1a, 1b main surface of quenched alloy strip
2 resin layer
11, 12 laminated magnetic material

1. A laminated magnetic material, comprising a plurality of quenched alloy strips and a resin layer made of resin and disposed between the quenched alloy strips, wherein an adhesive stress σ [MPa] represented by the following equation is 1.8 MPa or more where a modulus of elasticity of the resin at room temperature is denoted by γ [MPa], a coefficient of linear expansion of the resin at room temperature is denoted by α1 [1/K], a curing temperature of the resin is denoted by Ta [K], a coefficient of linear contraction of the resin during curing is denoted by β, a resin thickness of the resin is denoted by h1 [μm], a thickness of the quenched alloy strips is denoted by h2 [μm], a coefficient of linear expansion of the quenched alloy strips is denoted by α2 [1/K], and the room temperature is denoted by RT,
$$σ = h 1 / h 2 \times γ \times \{ ( α1 - α2 ) \times ( T a - R T ) + β \} .$$

2. The laminated magnetic material according to claim 1, wherein the laminated magnetic material has an iron loss Pcm of 13.0 W/kg or less at a frequency of 2000 Hz and a maximum magnetic flux density of 1.0 T.

3. The laminated magnetic material according to claim 1, wherein the laminated magnetic material has an eddy current loss Pe of 9.5 W/kg or less among an iron loss Pcm at a frequency of 2000 Hz and a maximum magnetic flux density of 1.0 T.

4. A method for manufacturing a laminated magnetic material comprising a plurality of quenched alloy strips and a resin layer made of resin and disposed between the quenched alloy strips,
the method comprising a step of applying the resin, and a step of curing the resin by laminating the quenched alloy strips, wherein an adhesive stress σ [MPa] represented by the following equation is 1.8 MPa or more where a modulus of elasticity of the resin at room temperature is denoted by γ [MPa], a coefficient of linear expansion of the resin at room temperature is denoted by α1 [1/K], a curing temperature of the resin is denoted by Ta [K], a coefficient of linear contraction of the resin during curing is denoted by β, a resin thickness of the resin is denoted by h1 [μm], a thickness of the quenched alloy strips is denoted by h2 [μm], a coefficient of linear expansion of the quenched alloy strips is denoted by α2 [1/K], and the room temperature is denoted by RT,
$$σ = h 1 / h 2 \times γ \times \{ ( α1 - α2 ) \times ( T a - R T ) + β \} .$$

5. The laminated magnetic material according to claim 2, wherein the laminated magnetic material has an eddy current loss Pe of 9.5 W/kg or less among an iron loss Pcm at a frequency of 2000 Hz and a maximum magnetic flux density of 1.0 T.
